(19) United States
(12) Patent Application Publication
(10) Pub. No.: US 2016/0150218 A1
(43) Pub. Date: May 26, 2016

(54) COMBINED STRUCTURE FOR HEAD UP DISPLAY SYSTEM AND DRIVER MONITORING SYSTEM

(71) Applicant: HYUNDAI MOTOR COMPANY, Seoul (KR)

(72) Inventor: Il Yong YOON, Seoul (KR)

(73) Assignee: HYUNDAI MOTOR COMPANY, Seoul (KR)

(21) Appl. No.: 14/849,356

(22) Filed: Sep. 9, 2015

(30) Foreign Application Priority Data
Nov. 26, 2014 (KR) 10-2014-0166431

(51) Int. Cl. H04N 13/02; G02B 5/20; G06K 9/00; G02B 27/01

(52) U.S. Cl. CPC H04N 13/0253; G02B 27/0101; G02B 5/208; G06K 9/00845; G06K 9/00275; H04N 13/0207; G02B 2027/0114; G02B 2027/0138; G02B 2027/014; G02B 2027/0194

(57) ABSTRACT

A combined structure for a head up display (HUD) system and a driver monitoring system, includes a HUD system including a first reflective portion and a second reflective portion configured to reflect HUD information from a HUD device to a windshield glass of a vehicle along an optical path. The combined structure further includes a dichroic mirror disposed on the optical path of the HUD system and configured to reflect specific wavelength of light. The combined structure also includes a driver monitoring system with driver's face information input thereto, and configured to provide light and to monitor a driver. Accordingly, driver's eyes are not hidden so as to improve safety and to simultaneously minimize deviation in driver's pose to enhance use convenience. The HUD system and the driver monitoring system are integrated to reduce a camera interval and a camera size, thereby improving marketability.

### CROSS-REFERENCE TO RELATED APPLICATION

This application is based on and claims the benefit of priority to Korean Patent Application No. 10-2014-0166431, filed on Nov. 26, 2014 in the Korean Intellectual Property Office, the disclosure of which is incorporated herein in its entirety by reference.

### TECHNICAL FIELD

The present disclosure relates to a combined structure for a head up display (HUD) system and a driver monitoring system, and more particularly, to a combined structure of a HUD system and a driver monitoring system, for preventing driver's front view from being blocked by a driver monitoring system.

### BACKGROUND

In general, use of a driver monitoring system (DMS) or an eye tracking technology as an advanced version of the DMS has been on the rise among advanced driver assistance systems (ADASs).

However, there is inconsistency in that a DMS or an eye tracker needs to monitor a driver's face and for this monitoring, the driver's face needs to be as close to the front as possible without driver's eyes been blocked by an illumination or a camera. Thus the degree of freedom in terms of a position of the DMS or the eye tracker system is limited.

Moreover, installation of an eye tracker system may cause a problem in terms of additional assembly and cost in addition to the DMS cost.

A conventional head up display (HUD) system includes a mirror configured to be packaged with a display device and a concave mirror for magnifying an image and increasing the number of positions of imaginary images. A conventional eye tracker includes a stereo camera for recognizing a face, glint and an infrared illumination.

However, conventionally, a position for installing a stereo camera for appropriately observing a face and glint without hiding eyes is limited. Thereby, even if eyes are not hidden by the stereo camera, the workability of the HUD may be limited. In other words, since the stereo camera is installed on a windshield glass, the convenience of using the HUD is limited, and since the stereo camera needs to be packaged, assembly and cost may be undesirable.

### SUMMARY

The present disclosure has been made to solve the above-mentioned problems occurring in the prior art while advantages achieved by the prior art are maintained intact.

An aspect of the present disclosure provides a combined structure for a head up display (HUD) system and a driver monitoring system, more particularly, a combined structure for a HUD system and a driver monitoring system for preventing driver's front vision from being hidden by a driver monitoring system.

According to an exemplary embodiment of the present disclosure, a combined structure for a head up display (HUD) system and a driver monitoring system includes a HUD system including a first reflective portion and a second reflective portion and configured to reflect HUD information from a HUD device to a windshield glass of a vehicle along an optical path. The combined structure for a head up display (HUD) system and a driver monitoring system also includes a dichroic mirror disposed on the optical path of the HUD system and configured to reflect a specific wavelength of light. The combined structure for a head up display (HUD) system and a driver monitoring system further includes a driver monitoring system with driver's face information input thereto, and configured to provide light and to monitor a driver.

According to another exemplary embodiment of the present disclosure, a combined structure for a head up display (HUD) system and a driver monitoring system includes a HUD system including a first reflective portion and a second reflective portion and configured to reflect HUD information from a HUD device to a windshield glass of a vehicle along an optical path. The combined structure for a head up display (HUD) system and a driver monitoring system also includes a translucent mirror disposed on the optical path of the HUD system and including an infrared pass filter configured to reflect an infrared wavelength of light. The combined structure for a head up display (HUD) system and a driver monitoring system further includes a driver monitoring system with driver's face information input thereto, and configured to provide light and to monitor a driver.

The HUD device and the first reflective portion may be set to be positioned on the same line level. The second reflective portion may be set to be positioned at an angle of 45 degrees based on the first reflective portion. The windshield glass may be set to be positioned at a fixed angle based on the first reflective portion.

The dichroic mirror may be disposed between the HUD device and the optical path of the first reflective portion.

The driver monitoring system may be disposed between the second reflective portion and the dichroic mirror.

The driver monitoring system may include a stereo camera with driver's face and glint information input thereto through the windshield glass. The driver monitoring system may also include an illuminating portion disposed at one end of the stereo camera and configured to provide a specific wavelength of light to the dichroic mirror.

The combination structure may further include a HUD film included in the windshield glass and configured to reflect the driver's face and glint information to the stereo camera.

The driver's face and glint information reflected through the HUD film may be reflected by the dichroic mirror through the second reflective portion and the first reflective portion and input to the stereo camera.

The specific wavelength of the illumination portion and the specific wavelength of the dichroic mirror may each be an infrared wavelength.

A distance between the driver monitoring system and the dichroic mirror and a distance between the dichroic mirror and the HUD device may be smaller than or the same.

### BRIEF DESCRIPTION OF THE DRAWINGS

The above and other objects, features and advantages of the present disclosure will be more apparent from the following detailed description taken in conjunction with the accompanying drawings.

FIGS. 1 and 2 are diagrams illustrating a combined structure for a head up display (HUD) system and a driver monitoring system according to the present disclosure.

### DETAILED DESCRIPTION

An exemplary embodiment will now be described more fully with reference to the accompanying drawings.

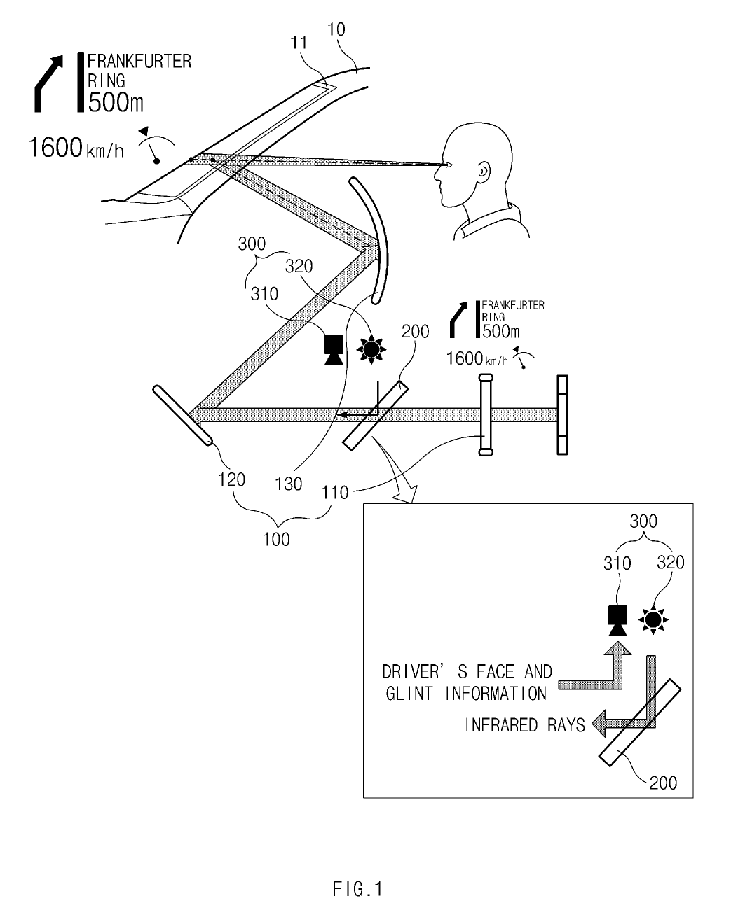

As illustrated in FIG. 1, a combined structure for a head up display (HUD) system and a driver monitoring system according to the present disclosure include a HUD system 100 for forming an optical path, a dichroic mirror 200 disposed on the optical path, and a driver monitoring system 300 providing an illumination to the dichroic mirror 200.

The HUD system 100 includes a first reflective portion 120, a second reflective portion 130, and a HUD device 110. Thus, the HUD device 110 may transmit HUD information along the optical path and then a windshield glass 10 of a vehicle may reflect the HUD information. The windshield glass 10 may receive the HUD information through the first reflective portion 120 and the second reflective portion 130 and reflect the HUD information towards the driver's face such that the driver can see the HUD information.

In this case, the HUD device 110 and the first reflective portion 120 may be set to be positioned on the same line level, the second reflective portion 130 may be set to be positioned at an angle of 45 degrees based on the first reflective portion 120, and the windshield glass 10 may be set to be positioned at an angle of 45 degrees based on the first reflective portion 120, and accordingly, the HUD information of the HUD device 110 may be projected on the windshield glass 10 via reflection.

The dichroic mirror 200 can be disposed on the optical path of the HUD system 100 and reflect a specific wavelength of light. In this case, the dichroic mirror 200 may be disposed between the HUD device 110 and the optical path of the first reflective portion 120.

According to another exemplary embodiment of the present disclosure, a translucent mirror (not shown) including an infrared pass filter may be used instead of the dichroic mirror 200 and disposed on the optical path of the HUD system 100 so as to reflect an infrared wavelength of light.

Driver face information may be input to the driver monitoring system 300 so as to provide light and to monitor the driver. In this case, the driver monitoring system 300 may be disposed between the second reflective portion 130 and the dichroic mirror 200.

The driver monitoring system 300 may include a stereo camera 310 to which driver's face and glint information is input through the windshield glass 10, and an illumination portion 320 disposed at one end of the stereo camera 310 and providing a specific wavelength of light to the dichroic mirror 200.

In this case, the windshield glass 10 may include a HUD film 11 for reflecting the driver's face and glint information toward the stereo camera 310, thereby enhancing performance for inputting driver's face information to the driver monitoring system 300.

Here, the driver's face and glint information reflected through the HUD film 11 is reflected by the dichroic mirror 200. The dichroic mirror 200 receives the driver's face and glint information through the second reflective portion 130 and the first reflective portion 120. The received driver's face and glint information is input to the stereo camera 310 such that the driver's face information can be used by the driver monitoring system 300.

The aforementioned specific wavelength of the illumination portion 320 and the specific wavelength of the dichroic mirror 200 may be an infrared wavelength.

Likewise, the dichroic mirror 200 for reflecting only an infrared wavelength may be positioned on the optical path of the HUD system 100 according to the present disclosure.

The dichroic mirror 200 may pass a specific wavelength of light and reflect a specific wavelength of light. In this regard, according to the present disclosure, the dichroic mirror 200 may be optimized to an infrared wavelength and an incident angle of 45 degrees.

Since the HUD information of the HUD system 100 is visible light, the HUD information may not be affected by the dichroic mirror 200, and thus the HUD system 100 can perform the same operation irrespective of the presence of the dichroic mirror 200.

In this case, infrared rays can be reflected by the reflectivity of the dichroic mirror 200 and combined along the optical path of the HUD system 100.

According to the present disclosure, it may not be necessary to use an additional infrared region filter due to the filter characteristics of the dichroic mirror 200.

Infrared rays that reach the windshield glass 10 along the optical path may be reflected according to infrared reflective characteristics of the HUD film 11 mounted on the windshield glass 10 and function as an infrared illumination.

In addition, the HUD system 100 may be configured such that the HUD information can be seen by driver's eyes and to create a viewing angle such that infrared rays also reach driver's face and eyes. The HUD system 100 may also have a function of adjusting an optical path according to a driver's pose so as to eliminate light deviation according to a driver's pose.

On the other hand, driver's face and glint information due to an infrared light source can be reflected by the windshield glass 10 and input to the stereo camera 310 of the driver monitoring system 300 through the dichroic mirror 200.

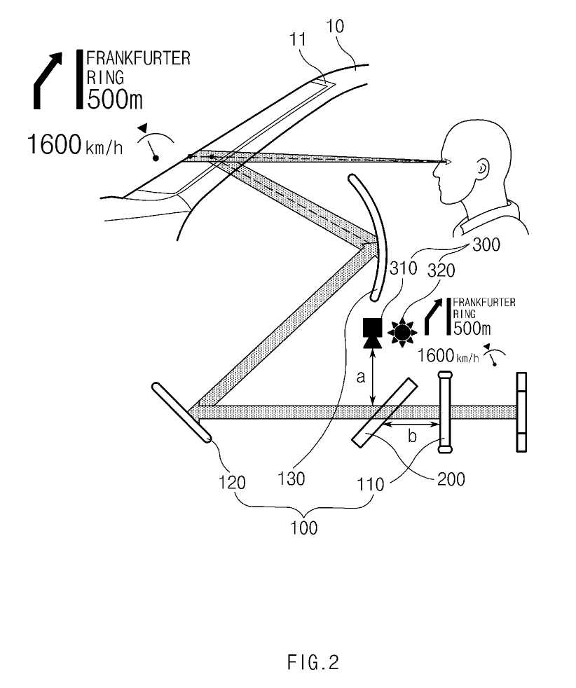

As illustrated in FIG. 2, a distance ‘a’ between the driver monitoring system 300 and the dichroic mirror 200 and a distance ‘b’ between the dichroic mirror 200 and the HUD device 110 may be the same, thereby preventing a double image from being generated according to a distance of an imaginary image from the HUD film 11.

Likewise, a combined structure according to the present disclosure may include the HUD system 100 including the first reflective portion 120 and the second reflective portion 130. The HUD information from the HUD device 110 can be reflected by the windshield glass 10 of a vehicle. The windshield glass 10 may receive the HUD information along the optical path. The dichroic mirror 200 included on the optical path of the HUD system 100 can reflect a specific wavelength of light. The driver monitoring system 300 receives driver's face information as input and provides light and monitors a driver. Accordingly, even if the driver monitoring system 300 is positioned in front of the driver, driver's eyes are not hidden and thus safety can be improved and deviation in driver's pose can be simultaneously minimized. Therefore, the HUD system 100 and the driver monitoring system 300 can be integrated so as to reduce a camera interval and a camera size, thereby improving marketability and user convenience.

While the present disclosure has been particularly shown and described with reference to an exemplary embodiment and drawings thereof, it will be understood by those of ordinary skill in the art that various changes in form and details may be made therein without departing from the spirit of the present disclosure as defined by the following claims.

What is claimed is:

1. A combined structure for a head up display (HUD) system and a driver monitoring system, the combined structure comprising:
a HUD system including a first reflective portion and a second reflective portion, configured to reflect HUD information from a HUD device to a windshield glass of a vehicle along an optical path;
a dichroic mirror disposed on the optical path of the HUD system and configured to reflect a specific wavelength of light; and
a driver monitoring system with driver's face information input thereto, and configured to provide light and to monitor a driver.

2. A combined structure for a head up display (HUD) system and a driver monitoring system, the combined structure comprising:
a HUD system including a reflective portion and configured to reflect HUD information from a HUD device to a windshield glass of a vehicle along an optical path;
a translucent mirror disposed on the optical path of the HUD system and including an infrared pass filter configured to reflect an infrared wavelength of light; and
a driver monitoring system with driver's face information input thereto, and configured to provide light and to monitor a driver.

3. The combined structure according to claim 1, wherein
the HUD device and the first reflective portion are set to be positioned on the same line level;
the second reflective portion is set to be positioned at an fixed angle based on the first reflective portion; and
the windshield glass is set to be positioned at a fixed angle based on the first reflective portion.

4. The combined structure according to claim 3, wherein the dichroic mirror is disposed between the HUD device and the optical path of the first reflective portion.

5. The combined structure according to claim 4, wherein the driver monitoring system is disposed between the second reflective portion and the dichroic mirror.

6. The combined structure according to claim 5, wherein the driver monitoring system includes:
a stereo camera with driver's face and glint information input thereto through the windshield glass; and
an illuminating portion disposed at one end of the stereo camera and configured to provide a specific wavelength of light to the dichroic mirror.

7. The combined structure according to claim 6, further comprising a HUD film included in the windshield glass and configured to reflect the driver's face and glint information to the stereo camera.

8. The combined structure according to claim 7, wherein the driver's face and glint information reflected through the HUD film are reflected by the dichroic mirror through the second reflective portion and the first reflective portion and input to the stereo camera.

9. The combined structure according to claim 6, wherein the specific wavelength of the illumination portion and the specific wavelength of the dichroic mirror are each an infrared wavelength.

10. The combined structure according to claim 5, wherein a distance between the driver monitoring system and the dichroic mirror and a distance between the dichroic mirror and the HUD device are smaller than or the same.
